(19) United States
(12) Patent Application Publication
(10) Pub. No.: US 2024/0378634 A1
(43) Pub. Date: Nov. 14, 2024

(54) TOKENIZATION FRAMEWORK FOR MARKETING CAMPAIGNS

(71) Applicant: COMMERCEFI LLC, McLean, VA (US)

(72) Inventors: Jin YU, Union City, CA (US); Sundeep SANGHAVI, Wesley Chapel, FL (US); Xunhui YU, North Wales, PA (US); Vivek RAO, North Bethesda, MD (US)

(73) Assignee: COMMERCEFI LLC, McClean, VA (US)

(21) Appl. No.: 18/661,668

(22) Filed: May 12, 2024

Related U.S. Application Data
(60) Provisional application No. 63/501,743, filed on May 12, 2023.

(51) Int. Cl. G06Q 30/0242; G06Q 20/36

(52) U.S. Cl. CPC G06Q 30/0243; G06Q 20/367

(57) ABSTRACT

According to an embodiment, the present application provides a method for marketing campaigns utilizing a tokenization framework, which relies on smart contracts for its operations. This method starts by accepting a campaign budget, which is for initiating the setup of a smart contract associated with this budget. The smart contract is responsible for the conversion of this budget into tokens, which are earmarked for distribution to users who enroll in the campaign. Operations of the smart contract include the periodic identification and verification of user-generated content relevant to the campaign. This is achieved by examining specific reference tags linked to the content. The smart contract evaluates the effectiveness of the content by analyzing engagement metrics, such as the number of views, likes, and comments. Based on these metrics, the smart contract calculates the appropriate token rewards for each participant.

### CROSS-REFERENCES TO RELATED APPLICATIONS

This application claims priority to U.S. Provisional Patent Application No. 63/501,743, filed May 12, 2023, entitled “A TOKENIZATION FRAMEWORK FOR MARKETING CAMPAIGNS”, which is commonly owned and incorporated by reference herein for all purposes.

### BACKGROUND OF THE INVENTION

Marketing campaigns are important tools for businesses of all sizes, serving to promote products and services across various media platforms, including emails, websites, mobile apps, and social media. Traditionally, these campaigns are conducted using fiat currencies, such as the US dollar. However, this conventional approach to marketing campaigns faces limitations, particularly in terms of transaction flexibility and global scalability.

Therefore, new and improved methods and systems for conducting marketing campaigns are desired.

### BRIEF DESCRIPTION OF THE DRAWINGS

FIG. 1 is a simplified flow diagram illustrating a tokenization framework used in a campaign process according to embodiments of the present invention.

FIG. 2 is a simplified flow diagram illustrating a token circulation process according to embodiments of the present invention.

FIG. 3 is a simplified flow diagram illustrating a token purchasing process according to embodiments of the present invention.

FIG. 4 is a simplified block diagram illustrating a platform for implementing tokenization frameworks according to embodiments of the present invention.

### DETAILED DESCRIPTION OF THE INVENTION

According to an embodiment, the present application provides a method for marketing campaigns utilizing a tokenization framework, which relies on smart contracts for its operations. This method starts by accepting a campaign budget, which is for initiating the setup of a smart contract associated with this budget. The smart contract is responsible for the conversion of this budget into tokens, which are earmarked for distribution to users who enroll in the campaign.

Operations of the smart contract include the periodic identification and verification of user-generated content relevant to the campaign. This is achieved by examining specific reference tags linked to the content. The smart contract evaluates the effectiveness of the content by analyzing engagement metrics, such as the number of views, likes, and comments. Based on these metrics, the smart contract calculates the appropriate token rewards for each participant.

As mentioned above, new and improved methods and systems for conducting marketing campaigns are desired. Among others, existing approaches to marketing campaigns face limitations, particularly in terms of transaction flexibility and global scalability. To address these challenges, a novel framework using blockchain technology has been proposed. This innovative approach leverages the benefits of blockchain, such as enhanced security, transparency, and the ability to facilitate micro-transactions. Utilizing blockchain technology in marketing campaigns, especially when executed through social media channels, affords the potential for increased engagement due to the network's viral effects.

The following description is presented to enable one of ordinary skill in the art to make and use the invention and to incorporate it in the context of particular applications. Various modifications, as well as a variety of uses in different applications, will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

Furthermore, the methods and processes described herein may be described in a particular order for ease of description. However, it should be understood that, unless the context dictates otherwise, intervening processes may take place before and/or after any portion of the described process, and further various procedures may be reordered, added, and/or omitted in accordance with various embodiments.

Unless otherwise indicated, all numbers used herein to express quantities, dimensions, and so forth should be understood as being modified in all instances by the term “about.” In this application, the use of the singular includes the plural unless specifically stated otherwise, and use of the terms “and” and “or” means “and/or” unless otherwise indicated. Moreover, the use of the terms “including” and “having,” as well as other forms, such as “includes,” “included,” “has,” “have,” and “had,” should be considered non-exclusive. Also, terms such as “element” or “component” encompass both elements and components comprising one unit and elements and components that comprise more than one unit, unless specifically stated otherwise.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items. By way of example, the phrases “at least one of A, B, and C” or “at least one of A, B, or C” each refer to only A, only B, or only C; and/or any combination of A, B, and C. In instances where it is intended that a selection be of “at least one of each of A, B, and C,” or alternatively, “at least one of A, at least one of B, and at least one of C,” it is expressly described as such.

It is to be appreciated the tokenization framework, according to embodiments of the present invention, can help enable share-to-earn economy for consumers, social users, content creators, and influencers. Additionally, tokenization framework can also help businesses and brands to establish a strong loyal community of customers and users.

As an example, the term “community” may refer to a “brand community”, which is an ecosystem wherein customers, partners, influencers, and employees can engage, support one another, and share experiences in real-time. This community facilitates a dynamic interface for real-time interactions and marketing initiatives, enhancing brand loyalty and user engagement. Influencers and existing customers play a pivotal role by inviting external users, including potential leads, to participate in the community. This mechanism enables the expansion of the community by incorporating new members who can engage in various promotional and social activities, thereby growing the brand's reach and influence. Among other features, a brand community supports the execution of marketing campaigns in real-time, allowing brands to dynamically interact with their community based on current trends, feedback, and engagement levels. This capability ensures that marketing efforts are timely, relevant, and highly tailored to the community's current interests and needs. Users within this community are incentivized to participate and engage through the distribution of digital tokens, referred to as community tokens. Regular community members receive community tokens as a reward for their ongoing participation and engagement with the brand. Influencers are rewarded with community tokens based on the effectiveness and reach of their campaign efforts, encouraging high-quality content creation and dissemination.

Community tokens serve as a versatile currency within the brand community, redeemable for a variety of goods and services. Users can exchange tokens for products offered by the brand. Community tokens can be used to enhance membership status, providing users with additional benefits and exclusive access. Community tokens may grant access to special events or activities, offering unique experiences to community members. Community Tokens can also be redeemed for gift cards or digital assets like non-fungible tokens (NFTs), adding a layer of flexibility and value to the rewards system.

Community tokens are utilized as a reward mechanism within a brand's community, awarded to users when they share content that is pertinent to the brand on various social media channels. For instance, a customer may be encouraged to share her experience on social media after purchasing a product, subsequently receiving community tokens as a reward for her contributions that align with the brand's marketing objectives.

In various implementations, a reward system is implemented using community tokens. The brand establishes a specific monthly reward budget, for example, $400. This budget is utilized to purchase an equivalent amount in USDC stable coins, which are then converted into community tokens. Assuming each token is valued at $0.01, the $400 would translate into 40,000 community tokens. These tokens are then allocated to a brand-specific budget pool, reserved for distribution as rewards.

It is to be appreciated that the brand has the flexibility to define specific actions that would trigger these rewards. These actions could range from purchasing merchandise to engaging with the brand in other significant ways. The brand also determines the amount of tokens to be awarded, which could be a flat rate or a percentage of the purchase price, providing a customizable and scalable reward system.

A Reward Manager system may be implemented for tracking these predefined actions and monitoring social posts that qualify for rewards. This system ensures that only relevant and qualifying activities are rewarded, maintaining the integrity and effectiveness of the marketing campaign.

For example, the reward campaign continues until the budget pool of 40,000 community tokens is exhausted. These tokens are distributed to the community users according to the rules set by the brand, ensuring that each participant is compensated based on their level of engagement and contribution to the brand's promotional efforts.

A campaign application, implemented using smart contracts, serves as a digital platform where brands can list their marketing campaigns, enabling influencers to browse and select campaigns that align with the interests and demographics of their respective audiences. The campaign application facilitates targeted and effective dissemination of campaign content, leveraging the reach and influence of selected participants.

A brand may participate in community token adoption processes in various ways. For example, in a proxied participation model, brands contribute to campaign fees and set merchandise prices in fiat currency. This fiat currency is initially used to purchase stable coins, which are subsequently converted into community tokens. This model is designed to shield brands from the volatile price fluctuations of community tokens by minimizing their direct exposure to the cryptocurrency market. By transacting primarily in stable coins and converting these to community tokens as needed, brands can participate in tokenized campaigns while mitigating the financial risks associated with the fluctuating values of cryptocurrencies. This approach allows brands to capitalize on the benefits of blockchain technology and tokenization without bearing the full brunt of cryptocurrency market volatility.

A brand may also adopt a full participation model, which allows brands to engage more directly with the cryptocurrency aspect of the campaign marketplace. In this model, brands purchase and hold community tokens directly, using either soft wallets (software-based) or hard wallets (hardware-based) for token management. This arrangement means that brands are fully exposed to the inherent risks and potential rewards associated with community token price fluctuations. By owning and managing community tokens, brands potentially benefit from increases in token value but must also navigate the financial risks of market downturns. This model is suited for brands with higher risk tolerance and a strategic interest in integrating more deeply into the cryptocurrency and blockchain landscape.

Brands initiate a campaign by setting a specific budget; for example, a campaign may have a budget of $400. This amount is utilized to purchase 400 USDC stable coins, which are subsequently converted into community tokens at an assumed value of $0.01 each, resulting in a total of 40,000 community tokens. These tokens are allocated to a brand-specific budget pool, designated for compensating influencer participation.

The campaign application allows influencer who meets the campaign's audience criteria—such as location, interests, and demographics—to participate in the campaign. This ensures that the content shared is relevant to the audience it reaches, maximizing the impact and effectiveness of the marketing efforts. The campaign continues until the allocated budget of 40,000 community tokens is exhausted. The expenditure of these tokens is tied directly to the engagement metrics achieved by the shared content, including impressions, likes, and comments. This method ensures that influencers are rewarded proportionally to the engagement and reach of their content, aligning their incentives with the goals of the campaign.

Upon the conclusion of the campaign or when the token budget is depleted, the 40,000 community tokens are distributed among the participating influencers. The distribution is based on the performance metrics of the content each influencer has shared, providing a measurable and merit-based compensation system.

Participation in the Campaign Marketplace by influencers may be contingent upon the acquisition of membership NFTs. These NFTs can be stratified into several membership tiers, catering to various levels of access and privileges within the marketplace. The structure is designed to incentivize commitment and reward successful campaign participation by influencers.

Influencers may be required to purchase membership NFTs to engage with campaigns listed in the Campaign Marketplace. The purchase of these NFTs grants influencers the necessary credentials to access campaign opportunities, engage with brands, and receive rewards. The membership NFTs may be segmented into different tiers, each providing distinct benefits and levels of access within the marketplace. This tiered system allows influencers to choose a level of participation that matches their goals and the scale of their influence. The initial pricing of these membership NFTs can be determined post-token launch, reflecting the value and demand of the tokens at that time. This approach ensures that the pricing is aligned with current market conditions and the perceived value of access to the marketplace.

In addition to purchasing membership NFTs, influencers may have the opportunity to earn them. For example, NFTs can be awarded based on the aggregated total amount of tokens that an influencer accumulates from all participated campaigns. This reward mechanism encourages continuous and effective participation by influencers, as it allows them to upgrade their membership status and gain additional benefits through successful campaign engagements.

It is to be appreciated that tokenization frameworks according to embodiments of the present invention capitalize on network effects by encouraging the redistribution of campaign content across social networks.

As an example, influencers, such as Ian, generate a unique referral code that they share with their followers. This code is instrumental in tracking the origin and spread of campaign engagement through different layers of social networks. Followers, like Frank, use the referral code to register for specific campaigns on the marketplace. This registration links their subsequent campaign activities directly to the influencer who provided the referral code. When followers, such as Frank, re-share the campaign content, they are awarded tokens based on the performance metrics of that content, which may include the number of impressions, likes, and comments it generates. For instance, Frank could be awarded 1,000 tokens for highly effective re-sharing activities. The influencer who originated the referral, in this case, Ian, also benefits from the activities of their followers. Ian would receive a percentage of the tokens generated by his followers' activities. For example, Ian would receive 200 tokens, which is 20% of the tokens awarded to Frank.

As an example, the terms “consumers” (who purchase from brands), “social users” (e.g., Facebook, and Instagram users), “content creators” (who generate engaging content in forums and social media), and “influencers” (social users who have a large follower base) are interchangeably. These are individuals who may be involved in marketing campaigns and interact with brands on numerous occasions. Collectively, these individuals may be referred to as “users”. An objective is to enable a share-to-earn economy for them, where they generate engaging content relevant to some brands, they should be rewarded accordingly. For example, the rewards could be in the form of blockchain tokens.

One of the benefits of blockchain tokens is the support of micro-transactions. Unlike fiat currencies (e.g., the US dollar), a token may represent a fraction of a cent, for example, a token may have a value of 0.01 cents, and a transaction may be just a single token (or a million tokens). This means that payments to consumers could be made in very small amounts. It is to be appreciated that one of the objectives is to help brands (e.g., the terms “business” and “brand” are used interchangeably in this context) to build a strong and loyal community of users. This community includes the brand's customers, employees, partners, and others. When properly motivated, they can serve as advocates or ambassadors for the brand. For this purpose, brands could reward community members with blockchain tokens for creating and sharing content relevant to the brand on suitable media platforms. These tokens are intended to serve as an effective incentive, motivating community members to actively promote the brand.

In various embodiments, users may acquire tokens by engaging in marketing campaigns. For example, these tokens are referred to as “community tokens.” The structure of these campaigns may be different, but may be classified into two categories: community campaigns and public campaigns. For example, community campaigns are exclusive to existing users associated with the brand, fostering deeper brand loyalty and engagement. Public campaigns are open to all, broadening the brand's reach and inviting widespread participation to earn tokens.

The execution of marketing campaigns follows a structured process, applicable to both community and public campaigns, with the notable exception of the initial steps concerning campaign invitation and participation. The overall process for campaign execution is substantially similar, ensuring consistency in how campaigns are managed and how outcomes are measured, regardless of the campaign type. It is to be appreciated that a systematic approach streamlines the operational aspects of campaign management and ensures equitable token distribution among participants.

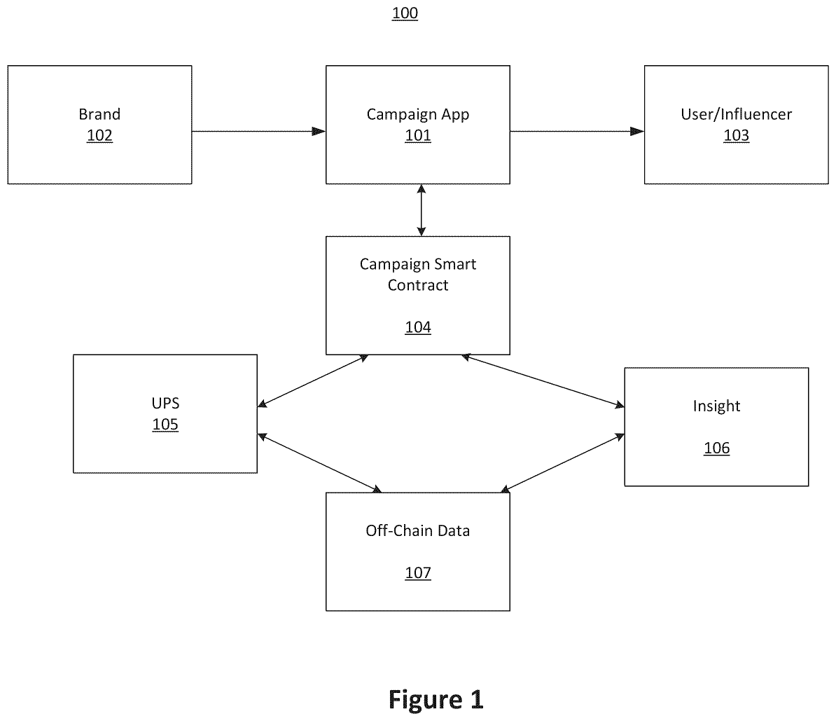

FIG. 1 is a simplified flow diagram illustrating a tokenization framework used in a campaign process according to embodiments of the present invention. This diagram is merely an example, which should not unduly limit the scope of the claims. One of ordinary skill in the art would recognize many variations, alternatives, and modifications. For example, one of more steps may be added, removed, repeated, replaced, modified, overlapped, and/or rearranged, and should not limit the scope of the claims.

At block 101, campaign application is provided. Depending on the implementation, the campaign application may be configured as a decentralized application (e.g., “dApp”), which operates on a decentralized network, such as a blockchain, utilizing smart contracts for backend logic. For example, data are distributed across the network, making it more secure and resistant to censorship. Control of the campaign app may be governed by code (e.g., smart contracts) and consensus mechanisms, ensuring transparency and immutability. No single entity has complete control. As an example, processes such as campaign budget allocation, tokenization, evaluation, and/or other processes may be defined and executed as smart contracts according to embodiments of the present invention.

According to various embodiments, the campaign application comprises a user-facing distributed application that offers a variety of business functionalities by calling the campaign smart contract to interact with the blockchain. The campaign smart contract may be a program running on the blockchain that manages token issuance, fund movement, and reward balances for the users.

At block 102, a brand allocates a campaign budget. For example, the brand allocates the campaign budget in fiat currency (e.g. $400) and transfers that to the campaign app at block 101. For example, the campaign app purchases $400 worth of stable coins from centralized crypto exchanges on behalf of the brand and deposits this fund into the brand's budget pool in the campaign smart contract. For example, the $400 could be used to purchase 400 USDC stable coins or 400 USDT stable coins. The need for stable coins is to isolate the brand from fluctuations of the pricing of the community token.

The 400 stable coins are further exchanged for community tokens via a decentralized exchange. For example, assuming each token is valued at 1 cent, this means 400 stable coins will be converted to 40,000 community tokens.

Campaign application engages users and/or users and/or influencers at block 103. For example, campaign application provides campaign invitations and participation, where users register and participate in the campaign. For example, in response users create contents relevant to the campaign and share it in the appropriate media channels. Depending on the implementation, the content must follow the rules defined at the campaign app (e.g., by the smart contract). For example, a campaign application may require that the content must include a reference tag designated by the campaign (e.g. hashtag) so that the campaign platform can attribute this content to the marketing campaign.

For example, in a community campaign, campaign invitations and participation may include the brand sending out invitations to selected community users to participate in this campaign. A user may accept the invitation and register for the campaign by connecting her crypto wallet and connecting to appropriate media channels (e.g., connecting to social networks to share content).

Depending on the implementation, there are various ways for a brand to reach out to community users. A prominent use case is “shop to earn”. For example, invitations are sent to users who purchased merchandise or services from the brand. An email invitation for the campaign may be automatically sent to the user after the shopping event. For example, an email may include text such as “Thank you for purchasing xyz. Would you like to share your purchasing experience? If you share your purchasing experience on Instagram, we will send you some tokens to show our appreciation!”

For public campaigns, the campaign invitation and participation may involve the brand publishing a campaign in an open marketplace, with appropriate criteria (e.g., number of participants, audience demographics). A user searches and browses for campaigns in the open marketplace and registers for the interested campaigns by connecting her crypto wallet and connecting to appropriate media channels (e.g., connecting to social networks to share content).

The campaign application, using smart contracts, measures results of the campaign, at block 104. For example, at a preset interval (e.g., daily), the campaign app calls the campaign smart contract to verify content relevance (or compliance with the smart contract) and to measure the performance. For example, to verify the user-generated content is relevant to the brand by calling a user profile store (UPS) service (or. UPS Oracle as explained below), at block 105. For example, UPS comprises data processing and analysis tools for processing content generated by users for a campaign. The UPS service may examine the content by checking the reference tag designed by the campaign. For example, if the campaign specifies a hashtag, the UPS service would check whether the content has the associated hashtag. The UPS service may also inspect the content to see if it contains the brand's logo or products.

Using insight service, performances of user contents are measured, at block 106. For example, insight service (or insight Oracle service) refers to a process that measures the performance of user-generated content, based on one or more predetermined performance metrics. In various embodiments, insight services may be configured to collect performance metrics, at block 107 (not on the same blockchain to ensure data safety), from the media where the content is posted, (e.g., social media networks such as Instagram, Reddit, or blog posts). For example, to measure the performance of user-generated content, the insight service is called, which could measure the performance of the content by examining multiple metrics, such as the number of views, likes, and positive comments. For example, the performance of user-generated content may be determined by the number of direct views, number of direct comments, number of direct clicks, number of reposts, number of views on reposts, number of comments on reposts, number of clicks on reposts, and others.

For example, oracle is a special construct that allows smart contracts to obtain data outside of the blockchain (e.g., internet websites, social media). Especially, the UPS oracle service is responsible for examining the user-generated content by checking the reference tag designed by the campaign, and the Insight oracle service is responsible for measuring the performance of the user-generated content by examining multiple metrics, such as the number of views, likes, and positive comments.

Based on the measurements obtained from the two oracle services above, the campaign smart contract calculates the amount of community tokens to be awarded to the user, at block 103.

A campaign does not run forever. For example, the campaign may end in various ways. The predefined ending date, and/or the campaign budget is exhausted. For example, upon the campaign ending, the total token amount according to the measurement from the oracle services may be added to the reward balance for the user together with the current timestamp.

After a campaign, community tokens are awarded to participating users. For example, community tokens are transferred to the crypto wallets of users using the campaign smart contract. In various implementations, tokens are not immediately transferred to their wallet. Instead, the tokens are kept in a reward balance in the campaign smart contract for a period, which allows for reducing gas fees from frequent transactions and minimizing selling pressure (e.g., quick selling of tokens by the users may result in depreciation of the token price).

In various embodiments, the campaign smart contract keeps a timestamp of the token reward from each campaign. This allows for a taxation scheme where the recent reward tokens can be taxed at a higher rate than older reward tokens. For example, the smart contract can support a tax schedule such as:
Tokens awarded 6 months or earlier have a tax rate of 5%
Tokens awarded between 3 and 6 months have a tax rate of 8%
Tokens awarded less than 3 months ago have a tax rate of 12%

To withdraw the tokens from the campaign smart contract to the user's wallet, the user would explicitly claim the tokens via the campaign smart contract and pay the appropriate amount of tax according to the tax schedule. This design discourages users from claiming tokens early and selling them and therefore decreases the selling pressure on the token ecosystem.

For example, users can spend their community tokens in the community commerce distributed application to purchase merchandise and services from the brands. As an example, brands can offer physical (e.g., t-shirts) and virtual merchandise (e.g., NFT) as well as services (e.g. gym memberships, events, and experiences).

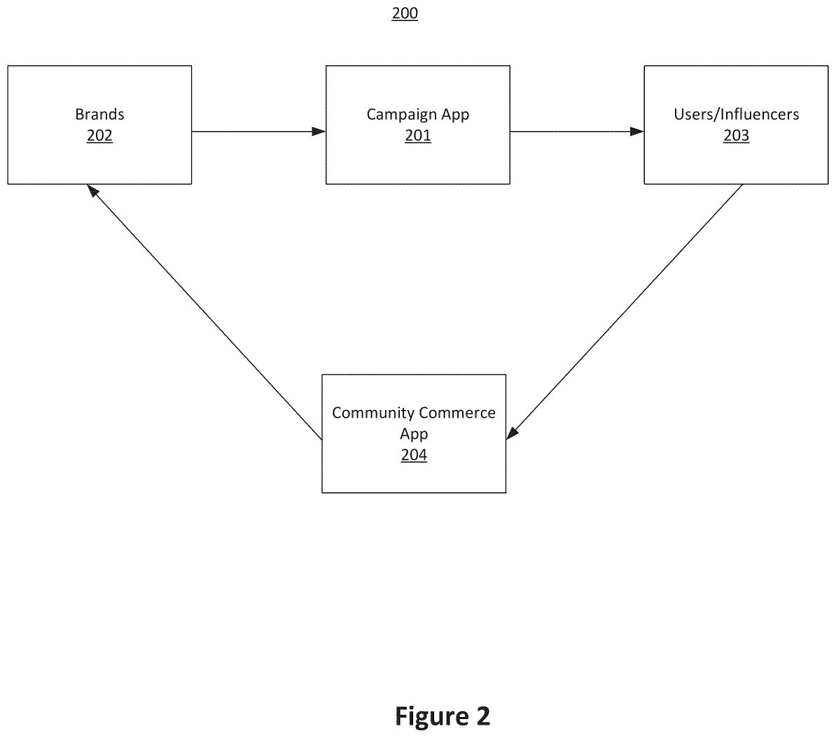

FIG. 2 is a simplified flow diagram illustrating a token circulation process according to embodiments of the present invention. This diagram is merely an example, which should not unduly limit the scope of the claims. One of ordinary skill in the art would recognize many variations, alternatives, and modifications. For example, one of more steps may be added, removed, repeated, replaced, modified, overlapped, and/or rearranged, and should not limit the scope of the claims.

For blockchain tokens and in general crypto-currency, circulation and liquidity are important to the health of the cryptocurrency ecosystem, including blockchain tokens. Effective utilization of the community token enhances its circulation, thereby increasing demand and potentially elevating its market price. When the community token is used often, circulation of the tokens increases, creating more demand for the tokens and the token price may be raised accordingly. In addition to circulation, token prices are driven by demand and supply.

For example, the term “buying pressure” is used to indicate the demand for purchasing the tokens, and the term “selling pressure” is used to indicate the supply of tokens to be sold. When the demand (or buying pressure) is higher than the supply (or selling pressure), the token price increases. Conversely, when the demand is lower than the supply, the token price decreases.

For the community tokens, the buying pressure primarily originates from the brands' campaign budgets. When the brand transfers the campaign budget to the campaign application, these funds are used to purchase community tokens at market price. This creates natural demand for the community tokens and increases its liquidity. The larger the campaign budget, the higher the demand is for purchasing the community tokens.

The selling pressure is from the users selling their earned tokens in exchange for cash. It is often desirable to minimize selling pressure. For example, embodiments of the present invention provide various mechanisms to minimize selling pressure. For example, a taxation scheme, as described above, may be used to discourage users from claiming token rewards early and selling them in decentralized exchanges. A staking reward mechanism may be used to encourage users to hold the tokens in staking smart contracts for interest earning. Spending tokens, to purchase merchandise and services from brands via the community commerce distributed application, increases the health circulation of the tokens.

In FIG. 2, campaign application 201 and community commerce application 204 are illustrated as distributed applications functioning on smart contracts. Specifically, campaign application 201 acts as a conduit through which brands 202 allocate their marketing budgets. It converts actual currency into community tokens, a process that may include intermediate steps such as purchasing stable coins and subsequently minting community tokens. For instance, using a campaign budget of $400 from brand 202, campaign application 201 distributes 40,000 community tokens to users 203.

The community commerce application 204 is configured to interact with community tokens. Users 203 engage with community commerce application 204 by spending their tokens on goods and services. For example, if users 203 spend 35,000 of the 40,000 tokens received, community commerce application 204 processes these transactions. For example, it converts the 35,000 spent tokens into $350 of net revenue and then transfers this amount back to brand 202. It is to be appreciated that system 200 provides an economic loop, allowing brands to recapture expended campaign funds through consumer purchases within the community, thus maintaining a fluid circulation and utilization of the tokens within the ecosystem.

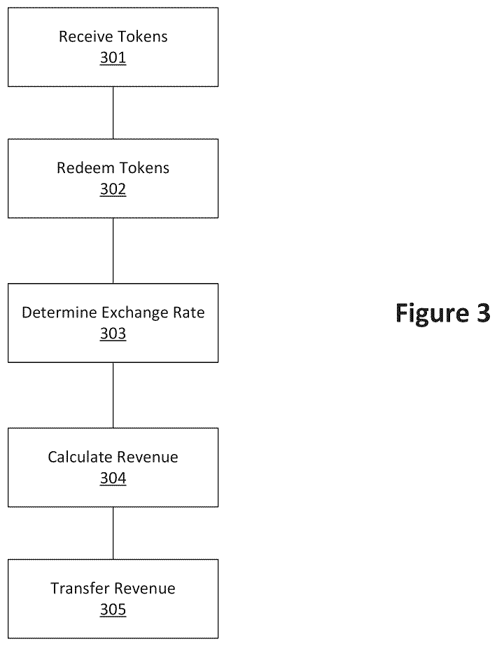

FIG. 3 is a simplified flow diagram illustrating a token purchasing process according to embodiments of the present invention. This diagram is merely an example, which should not unduly limit the scope of the claims. One of ordinary skill in the art would recognize many variations, alternatives, and modifications. For example, one of more steps may be added, removed, repeated, replaced, modified, overlapped, and/or rearranged, and should not limit the scope of the claims.

At step 301, the community commerce application, which is configured as a smart contract, begins the process by receiving tokens from users. For instance, it might receive 50,000 community tokens from a particular user, indicating the start of a transaction within the ecosystem.

Moving to step 302, the community commerce application enables users to redeem their community tokens for goods and services. The redemption rate at which tokens are valued can vary based on a user's status within the loyalty program. For example, a user with a 20% loyalty discount would enjoy increased purchasing power, allowing them to stretch the value of their tokens further than the base rate. In various embodiments, users enrolled in loyalty programs or those who have reached certain thresholds of engagement with the brand may receive bonuses such as discounts or enhanced token value. The prevailing market conditions, such as the fluctuation in token value or demand for tokens, can also influence the redemption rate. This ensures that the token economy remains responsive to external economic factors and helps stabilize the token's value.

In various implementations, users may be incentivized to hold onto their tokens longer by implementing a schedule that increases the value of tokens based on their holding period. For example, tokens redeemed after six months might carry a 10% bonus, whereas tokens held for a year could see a 20% increase in redemption value. Users who participate more frequently or extensively in campaigns could receive increasing discounts or better token rates over time. This approach rewards long-term engagement over short-term gains. Early redemption of tokens could incur a fee or a reduction in the token's redemption value. This penalty decreases as the holding period increases, thereby encouraging users to delay token redemption to maximize value. In some embodiments, the community commerce application limits the number of tokens that can be redeemed within a certain timeframe preventing large-scale withdrawals that could destabilize the token supply.

At step 303, the application determines the exchange rate of community tokens to fiat currency. This step defines the monetary value of the tokens at the time of the transaction. Using the example provided, 50,000 community tokens might be exchanged for $500, based on the current exchange rate and any user-specific adjustments such as loyalty discounts. The rate is calculated using pre-established mechanisms that consider market conditions and token supply and demand.

In step 304, the total revenue generated from the token transactions is calculated. Continuing with the previous examples, the conversion of 50,000 community tokens might result in $500 of net revenue. This calculation confirms the financial impact of token redemption on the platform.

At step 305, the net revenue is transferred to the brand, for example, the brand that initially funded the marketing campaign leading to these token distributions. This step closes the loop of the transaction, redistributing the economic value captured by the community tokens back to the originating brand, thereby reinforcing the economic cycle within the tokenized ecosystem. This process not only incentivizes user participation and brand loyalty but also ensures a sustainable flow of value back to the campaign initiators.

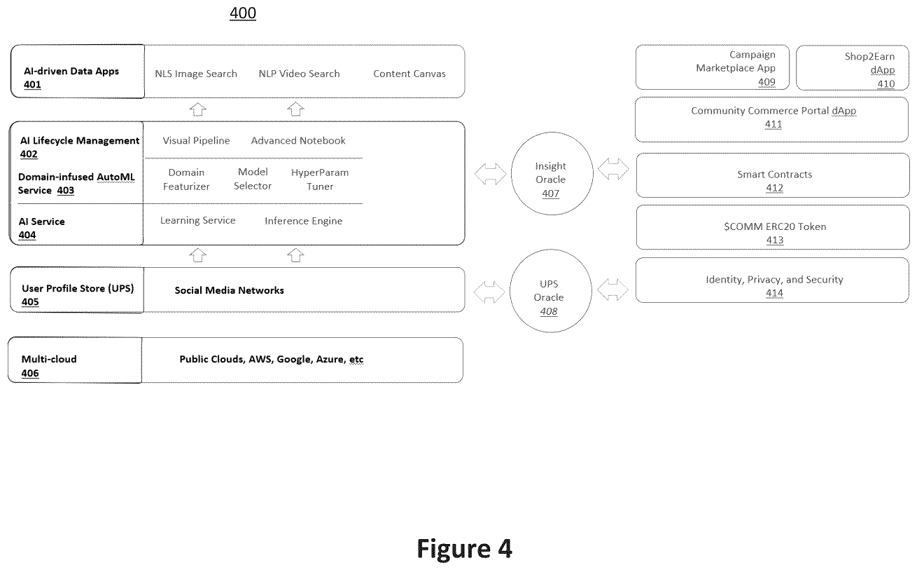

FIG. 4 is a simplified block diagram illustrating a platform 400 for implementing tokenization frameworks according to embodiments of the present invention. This diagram is merely an example, which should not unduly limit the scope of the claims. One of ordinary skill in the art would recognize many variations, alternatives, and modifications.

In platform 400, various types of artificial intelligence (AI) platforms can be utilized, depending on the specific implementation needs. This platform is structured to enhance functionality through the integration of AI-driven applications and services, ensuring sophisticated data handling and user interaction capabilities.

Block 401 serves as a hub for AI-driven data applications, which include advanced capabilities like natural language image search, natural language video search, and content canvas among others. These applications are designed to simplify and enhance the way users interact with digital content through intuitive search functionalities and creative data manipulation tools. For example, utilizing natural language processing (NLP) technologies, the platform enables users to perform searches using natural language phrases. This feature allows for intuitive query input, where users can describe in words the images they seek, enhancing the user-friendliness and accessibility of the search tool. At block 401, platform 400 supports image-based queries, where users can upload an image to search for visually similar images. This method employs sophisticated image recognition and comparison algorithms to identify and retrieve images that share visual characteristics with the input image, facilitating diverse applications such as style matching and content verification.

Block 402 provides AI lifecycle management, which is critical for maintaining and optimizing AI systems. This includes features like a visual pipeline for tracking AI processes and advanced notebook features that enable data scientists and developers to create, test, and deploy AI models efficiently.

Block 403 provides domain-infused machine learning services, which enhance the AI's understanding and processing of domain-specific data. This could involve a domain featurizer for tailoring data inputs, a model selector for choosing the most appropriate AI models based on performance criteria, and a hyperparameter tuner to optimize model settings for improved accuracy and efficiency.

Block 404 provides foundational AI services, including a learning service and an inference engine, essential for training AI models and making real-time decisions based on data inputs, respectively.

Blocks 402, 403, and 404 collectively feed data into block 401, enabling seamless integration and utilization of AI capabilities across the platform.

Block 405 provides user profile store (UPS), and it gathers and aggregates user data from various social media networks, which is then utilized by other blocks for enhanced personalization and targeting.

Block 406 utilizes cloud computing services, which can be either public or private, to support the scalable and flexible deployment of platform services and applications.

Block 407 involves the Insight Oracle, which analyzes data from blocks 402-404 to provide performance metrics essential for evaluating user engagement and content effectiveness.

Block 408, the UPS Oracle, leverages information from block 405 to perform various verifications, enhancing the security and relevance of user interactions on the platform. This includes verifying user identities during registration and checking the relevancy of user-generated content. For example, block 408 may provide tools to verify the authenticity of likes and comments on influencers' posts. By analyzing patterns and anomalies in engagement, the technology discerns genuine interactions from those manipulated by automated systems or fraudulent accounts, thereby preserving the quality and reliability of audience engagement metrics.

Block 412 encompasses the implementation of various smart contracts, including those for the campaign application and community commerce application, which are essential for automating token rewards and redemption processes based on user performance.

Blocks 409-411 comprise distributed applications implemented by block 412. For example, blocks 409-411 are implemented through block 412's smart contract capabilities, ensuring that all transactions and user interactions are secure and transparent.

Block 409, in various implementations, provides a campaign marketplace application that facilitates the browsing and management of marketing campaigns. which acts as a centralized platform where brands can launch, manage, and monitor their marketing campaigns. This application streamlines the process for brands to publish campaigns to a wide audience, making it accessible not only to existing community members but also to the general public who may be interested in participating. The campaign marketplace application allows brands to set detailed parameters for each campaign, including target demographics, participation criteria, and the budget in fiat currency, which is then converted into community tokens. Brands can track the progress of campaigns in real time, adjusting strategies based on user engagement and other performance metrics. This application is instrumental in enhancing the visibility and accessibility of marketing campaigns, ensuring a broader reach and more effective engagement strategies.

Block 410 is the shop-to-earn application, incentivizing users to engage with brand promotions.

Block 411 hosts the community commerce application, handling transactions where users can use their tokens to purchase goods or services. This application allows users to redeem their earned tokens by purchasing goods and services directly from brands. It serves as a bridge between the digital token economy and tangible value, offering users a tangible return on their engagement with brand campaigns. In the community commerce application, users can browse a wide range of products and services offered by participating brands. The application supports a conversion system where the value of community tokens against fiat currency is determined, often influenced by factors such as market conditions and user loyalty status, as previously described. For example, users with a higher loyalty status may receive favorable conversion rates, enhancing their purchasing power. The community commerce application may be configured to encourage sustainable token circulation within the ecosystem. It implements mechanisms to discourage the immediate liquidation of tokens by applying graduated rewards or penalties based on the timing of token redemption. This approach aims to stabilize the token economy and ensure its longevity and robustness, benefiting both the brands and the users by maintaining token value and encouraging long-term engagement.

Block 413 sees the generation of tokens by the smart contracts housed within Block 412, which are crucial for the token economy's functionality within the platform.

It is to be appreciated that platform 400 provides tokenization frameworks with many advantages, facilitating the establishment of a share-to-earn economy, and empowering social users, influencers, and content creators to earn compensation by generating engaging content for the brands they support. Tokenization frameworks according to embodiments of the present invention harness the capabilities of social influencers and content creators to bolster brand engagement and loyalty. Users can receive rewards in the form of tokens or other digital assets, aligning their creative efforts with tangible incentives. By actively participating in marketing initiatives, these individuals contribute to a vibrant, interactive community around the brands, enhancing the brand's presence and reputation across various media platforms. Tokenization frameworks according to embodiments of the present invention support brands in building and sustaining a strong, loyal community of users. By leveraging the influence and creative output of social influencers and content creators, brands can enhance their market visibility and consumer engagement more effectively than traditional marketing strategies allow. This approach not only drives user engagement through innovative reward systems but also fosters a sense of community and loyalty among users, which is vital for long-term brand success.

According to an embodiment, the present application provides a method for marketing campaigns utilizing a blockchain framework, which relies on smart contracts for its operations. This method starts by accepting a campaign budget, which is for initiating the setup of a smart contract associated with this budget. The smart contract is responsible for the conversion of this budget into tokens, which are earmarked for distribution to users who enroll in the campaign. Operations of the smart contract include the periodic identification and verification of user-generated content relevant to the campaign. This is achieved by examining specific reference tags linked to the content. The smart contract evaluates the effectiveness of the content by analyzing engagement metrics, such as the number of views, likes, and comments. Based on these metrics, the smart contract calculates the appropriate token rewards for each participant.

The method also includes the acquisition and transformation of stable coins into tokens. This process includes purchasing stable coins from centralized crypto exchanges, which are then converted into tokens used within the campaign. The method defines how participants are selected and invited to join the campaign, which includes integrating their cryptocurrency wallets and connecting to relevant media channels for content dissemination.

One of the roles of the smart contract is to determine the endpoint of the campaign, which can occur either when the campaign budget is depleted or on a predetermined closing date. The smart contract also handles the redistribution of any remaining budget at the campaign's conclusion.

On the blockchain, the system manages both the issuance of new tokens and the allocation of rewards to users. The process identifies users potentially based on their historical purchases and allocates token rewards to their wallets. Notably, the transfer of tokens may involve a discount rate that adjusts based on the timing of the transaction.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A method comprising:
receiving a budget for a campaign;
generating a smart contract associated with the budget and the campaign;
calculating a number of tokens based at least on the budget;
providing the number of tokens;
registering a plurality of user for the campaign;
identifying contents generated by the plurality users for the campaign;
verifying relevancies of the contents at a predetermined interval using at least the smart contract;
measuring performances of the contents using the smart contract and predetermined metrics; and
calculating token reward balances for the plurality of users based at least on the relevancies and the performances.

2. The method of claim 1, further comprising:
purchasing a number of stable coins from a centralized crypto exchange; and
exchanging the number of stable coins to the number of tokens.

3. The method of claim 2, further comprising exchanging the number of stable coins to the number of tokens.

4. The method of claim 1, further comprising selecting and inviting the plurality of users to the campaign.

5. The method of claim 1, further comprising verifying reference tags associated with the contents.

6. The method of claim 1, wherein the performance metrics comprise number of views and comments.

7. The method of claim 1, wherein the calculation of token reward balances is defined by the smart contract, the smart contract being configured as a decentralized application.

8. The method of claim 1, further comprising ending the campaign on a predetermined date.

9. The method of claim 8, further comprising distributing unused budgets.

10. The method of claim 1, further comprising ending the campaign in response to exhaustion of the budget.

11. The method of claim 1, further comprising providing a blockchain associated with the smart contract, the smart contract being configured to manage token issuance and token rewards.

12. The method of claim 1, further comprising connecting the plurality of users to their crypto wallets.

13. The method of claim 1, further comprising connecting the plurality of users to media channels.

14. The method of claim 1, further comprising identifying the plurality of users based on purchase histories.

15. The method of claim 1, further comprising transferring the number of tokens to the plurality of users based on the token reward balances.

16. The method of claim 15, further comprising calculating a discount rate based on a time of transfer.

17. A method comprising:
generating a smart contract defining a token issuance and a token reward;
storing the smart contract on a blockchain;
calculating a number of tokens for a campaign using at least the smart contact;
registering at least a first user for the campaign;
identifying a content generated by the first user for the campaign;
verifying a relevancy of the content at a predetermined interval using at least the smart contract;
measuring a performance of the content using the smart contract and predetermined metrics; and
calculating a token reward balance for first user based at least on the relevancy and the performance.

18. The method of claim 17, further comprising connecting to a crypto wallet of the first user.

19. The method of claim 17, further comprising transferring tokens to the first user using at least the smart contract.

20. The method of claim 17, further comprising adjusting token price in response to the first user spending tokens.
